(19) United States
(12) Patent Application Publication
(10) Pub. No.: US 2024/0001452 A1
(43) Pub. Date: Jan. 4, 2024

(54) Guide device for bars

(71) Applicant: CUCCHI GIOVANNI & C. S.r.l., Bussero (IT)

(72) Inventor: Cesare CUCCHI, Bussero (IT)

(21) Appl. No.: 18/253,843

(22) PCT Filed: Nov. 26, 2021
(86) PCT No.: PCT/IB2021/061009

§ 371 Date: May 22, 2023

(30) Foreign Application Priority Data
Nov. 27, 2020 (IT) 102020000028799

(51) Int. Cl. B23B 13/02

(52) U.S. Cl. CPC B23B 13/021

(57) ABSTRACT

A guide device for bars to be fed to a machine tool includes first holding and guide arrangement and second holding and guide arrangement, arranged to define an advancement zone for the bars that extends according to a longitudinal axis. The first holding and guide arrangement and the second holding and guide arrangement are configured to establish one or more contact zones with the bar, so as to hold in position and guide the bar along the advancement zone. The first holding and guide arrangement and the second holding and guide arrangement extend parallel to the axis and are positioned on sides mutually opposite the longitudinal axis. The first holding and guide arrangement and the second holding and guide arrangement are relatively movable between a rest position, in which the first and the second holding and guide arrangement are at a greater mutual distance and at furthest positions from the advancement zone to allow the positioning of said bar to be guided along the advancement zone, and an engagement position, in which the first and the second holding and guide arrangement are at a lesser mutual distance and nearer the advancement zone so as to come into contact with the bar, adapting to different diameter values of the bar.

### BACKGROUND OF THE INVENTION

The present invention relates to a guide device for an apparatus for automatic loading of bars for a machine tool, like a lathe that can be of the single-spindle or multiple spindle type.

Different apparatuses are known for guiding and feeding bars to the spindles of a lathe. In general, a bar-feeding apparatus includes a drum that is rotatable around a horizontal longitudinal axis thereof and supports a plurality of guides suitable for containing and guiding respective bars to be fed to the aforesaid lathe. The guides are distributed both longitudinally along the drum and circumferentially on the latter.

Current systems for advancing and loading bars for machining on machine tools are generally configured with structures that are very complex both from the structural and functional point of view with connected drawbacks and limits like unsatisfactory levels of reliability and high management and maintenance costs.

More precisely, in relation to the bar guide systems, it should be pointed out that the corresponding structural complexity and the considerable overall dimensions, do not facilitate but on the contrary slow the operations of loading the bars. All this has a negative impact on the levels of productivity of the apparatuses.

It should be further noted that current guide systems do not prove to be sufficiently versatile to adapt each time to specific production needs. To give an example, known guide systems are not able to adapt to bars with sections of different dimensions.

One known example of a guide device includes pairs of semicylindrical elements that are mutually hinged and connected to a drum. In each pair, one of the two semicylindrical elements is in a stationary position with respect to the drum, whereas the other semicylindrical element is movable with respect to the drum. In an open position, the semicylindrical elements are not in mutual contact, are thus spaced apart from one another, so as to permit loading of the bar. In a closed position, the two semicylindrical elements are near one another and in mutual contact to convey and guide the bar to the machine tool.

The aforesaid system is hardly versatile in adapting to different dimensions of the bars to be guided. With a guide device that is so shaped, it is in fact not possible to convey bars having a diameter that is greater than the diameter of the zone bounded inside by the two semicylindrical elements.

Further, problems can arise with loading slim bars, i.e. having a diameter less than the diameter of the guides. In fact, problems can arise in using a guide system having a diameter that is greater than the diameter of the bar to be loaded, because the great extra space available inside the guide, i.e. the resulting gap between the bar and guide surfaces causes unsuitable positioning with the risk of causing jamming of the bar, in particular at the final section facing the lathe.

Incorrect use of the aforesaid guide system can lead to malfunctions for the loading system. Thus, in the case of a variable diameter of the bars to be loaded, it is necessary to replace or modify the guide system so as to adapt the diameter of the bars to be loaded, for example by inserting spacers and/or suitable reduction gears inside the conveying zone, to reduce the free space and adapt the guide device to bars having a smaller diameter.

This entails a significant expenditure of time by the user with clear drawbacks from a financial point of view caused by different factors, from the need to have guides having different sections to the costs and maintenance and replacement of the guides.

Basically, known feeding apparatuses have various limits summarized below. One first limit is in general set by the great complexity both from the structural and functional point of view of the bar loading and guide mechanisms. This often involves unsatisfactory operating times from the point of view of envisaged productivity.

A second limit is that of the possible occurrence of drawbacks using the guide units, that do not always ensure correct advancement of the bars, especially in the case of bars with a very reduced diameter with respect to the inner section of the guide units.

A third limit, which is a consequence of the structural complexity of known apparatuses, is represented by the inevitable occurrence of greater reliability problems, with resulting costly maintenance interventions. The structural complexity caused by current loading and guide systems entails rather high production costs and complicates operations of possible maintenance or replacement of parts, also inevitably causing lengthy machine downtime, with resulting financial losses for the user.

Other guide devices for bars are known from EP3456444 and EP0384344.

In the light of the above, there is ample room for improvement of current bar-feeding apparatuses.

### SUMMARY OF THE INVENTION

One object of the present invention is to improve and simplify structurally and functionally apparatuses for guiding, feeding and advancing bars to machine tools.

Another object of the present invention is to provide a versatile guide device that is able to adapt to different production needs, for example to bars having a small diameter.

Another object is to provide a guide device for advancing and feeding bars provided with a higher operating speed, which is able to lower drastically bar-feeding cycle times.

A further object is to provide a guide device for advancing and feeding bars that, having a more simplified structural and functional configuration than known apparatuses, results in lower manufacturing and maintenance costs and shorter downtime for maintenance.

A further object of the present invention is to provide a guide device that is easy to mount on any existing bar-feeding apparatus, with clear advantages in terms of cost and assembly time.

The above can be achieved by the solution as defined in the attached claims.

In particular, the apparatus according to the invention is structurally configured in a manner that is simplified with respect to prior art apparatuses, and this results in an increase in mechanical reliability and also a reduction in manufacturing and maintenance costs.

The particular configuration of the apparatus, owing to the guide and containment action performed by the second holding and guide arrangement, enables possible flexure to be minimized of bars being advanced and rotated and is able to adapt to bars having a diameter included in a wide range, in particular to slim bars, i.e. having very reduced cross sections.

Owing to the solution according to the invention, all the objects set out above are achieved.

### BRIEF DESCRIPTION OF THE DRAWINGS

These and further features, according to the present invention, will be clearer from the following description with reference to the attached drawings, in which:

FIG. 1 shows the guide device for bars to be fed to a machine tool according to the invention;

FIG. 2 shows a detail of the guide device in FIG. 1;

FIG. 3 is a side view of the guide device;

FIG. 4 is a side view of the guide device in an operating mode;

FIG. 5 is a cross section of the guide device;

FIG. 6 is a cross section of the guide device shown in FIG. 4;

FIG. 7 is a side view of part of a bar-feeding apparatus that supports the guide device according to the invention;

FIG. 8 shows schematically the operation of an advancement device included in the feeding apparatus;

FIGS. 9 and 10 show, in a section view, two embodiments of the guide device according to the invention, with which an advancement device of the belt or conveyor type is coupled according to two different possible configurations;

FIG. 11 shows, in section, a further embodiment of the guide device coupled with a different type of advancement device;

FIG. 12 shows another embodiment of an advancement device included in the feeding apparatus in a rest position;

FIG. 13 shows the advancement device of FIG. 10 in an operating position.

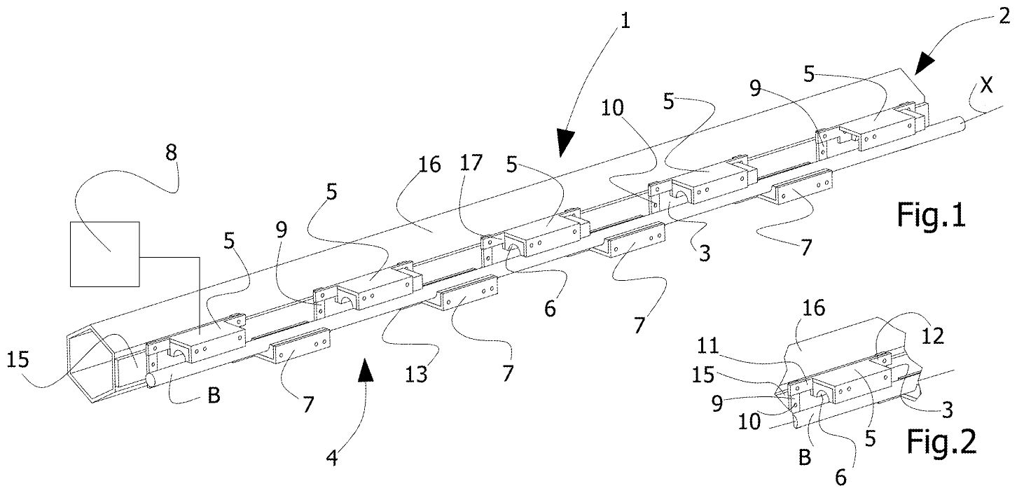

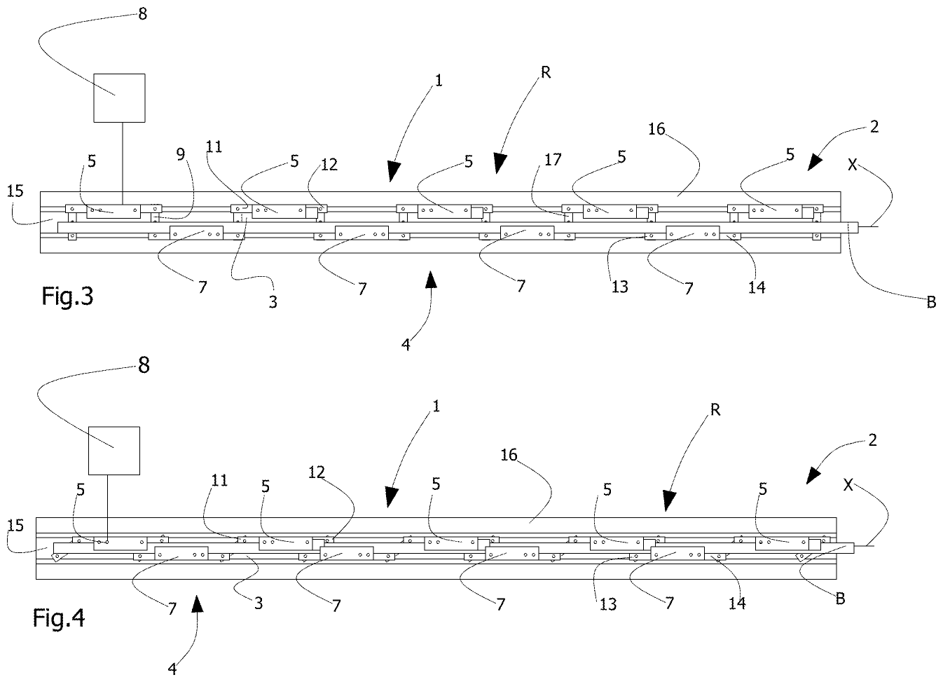

### DETAILED DESCRIPTION

With reference to the attached Figures, a guide device 1 is shown for guiding and conveying automatically bars B to a machine tool such as for example a lathe, which can be of the single spindle or multispindle type.

The guide device 1 includes a first holding and guide arrangement 2,5 and second holding and guide arrangement 4,7, arranged so as to define an advancement zone 3 for the bars B to be fed to the lathe.

The advancement zone 3 extends along a longitudinal axis X that can, for example, coincide with the longitudinal axis of the cylindrical bars B to be conveyed to the machine tool.

The first holding and guide arrangement 2,5 and the second holding and guide arrangement 4, 7 are configured to establish one or more contact zones with the bar B, so as to hold in position and slide longitudinally the bar B along the advancement zone 3 that is defined by the first holding and guide arrangement 2,5 and the second holding and guide arrangement 4,7.

The first holding and guide arrangement 2,5 and the second holding and guide arrangement 4,7 extend parallel to the axis X and are positioned on sides mutually opposite the longitudinal axis X.

The aforesaid first holding and guide arrangement 2, 5 and second holding and guide arrangement 4, 7 are relatively movable between a rest position R and an engagement position L. When arranged in the rest position R, the first holding and guide arrangement 2,5 and the second holding and guide arrangement 4,7 are at a greater mutual distance and in positions that are further from the advancement zone 3, in order to enable the bar B to be guided along the advancement zone 3 to be positioned therebetween.

When arranged in the engagement position L, the first holding and guide arrangement 2,5 and the second holding and guide arrangement 4,7 are at a lesser mutual distance and nearer than the advancement zone 3, so as to come into contact and maintain the bar B in the correct position along an advancement direction A.

More precisely, on the first holding and guide arrangement 2,5 and on the second holding and guide arrangement 4,7, housing seats 6 are obtained that are suitable for receiving and guiding the bars B. Each housing seat 6 has, according to a transverse plane, a curved concave profile.

In the embodiment shown in the attached figures, the housing seats 6 of the first holding and guide arrangement 2,5 and of the second holding and guide arrangement 4,7 have, according to a transverse plane, a profile of semicircular shape that is such as to bound, when the first holding and guide arrangement 2,5 and the second holding and guide arrangement 4,7 are coupled with one another, a cylindrical advancement zone 3 having a diameter D.

In this direction, the first 2,5 and the second 4,7 holding arrangement are configured to adapt to different diameter values of the bar B. In particular, the guide device 1 that is so configured can guide bars B having a diameter that is the same as or less than the reference diameter D.

The housing seat 6 is coated with or obtained integrally with a material having antifriction properties, in order to avoid obstacles to and slowing of the sliding of the bar B inside the advancement zone 3. For example, the housing seat 6 can be coated with or obtained integrally with a piece of material having anti-friction properties chosen from a group including: polytetrafluoroethylene (PTFE), a polyamide containing graphite, a metal or metal alloy coated with graphite or a ceramic material.

The guide device 1 further includes a driving member 8 connected to an end of the first holding and guide arrangement 2,5 and/or of the second holding and guide arrangement 4,7 to move the first holding and guide arrangement 2,5 and the second holding and guide arrangement 4,7 between the rest position R and the engagement position L. The driving member 8 includes a hydraulic or pneumatic actuator.

In one embodiment of the invention, shown in the attached figures, the first holding and guide arrangement 2,5 includes a first series 2 of distinct guide elements 5 having a block shape. The guide elements 5 are mutually spaced apart and distributed parallel to the axis X.

The second holding and guide arrangement 4,7 includes a second series 4 of distinct block-shaped guide-elements 7. The guide elements 7 are mutually spaced apart and distributed parallel to said axis X, in a position opposite the guide elements 5 of the first series 2.

More precisely, the guide elements 5 of the first series 2 are arranged staggered with respect to the guide elements 7 of the second series 4, so as to entirely involve the advancement zone 3 and, consequently, the bar B to be guided inserted into the aforesaid zone. The guide elements 5 of the first series 2 are connected mechanically to the guide elements 7 of the second series 4 by connecting members 9, so as to form an articulated guide structure 17.

Owing to the reciprocal mechanical connection between the guide elements 5 and 7, the first series 2 of guide elements 5 and the second series 4 of guide elements 7 are movable in a simultaneous and synchronised manner between the rest position R and the engagement position L.

The connecting members 9 includes connecting rod elements 9, the ends of which are connected respectively to a guide element 5 of the first series 2 and to a guide element 4 of the second series 7.

The connecting rod elements 9 are configured to rotate around respective pivots 10. The pivots 10 are provided in an intermediate zone of the respective connecting rod elements 9 and in a middle zone interposed between the first series 2 of guide elements 5 and the second series 4 of guide elements 7. In this manner, the rotation of the connecting rod elements 9 results in a displacement that is equal but in opposite directions of the first series 2 of the guide elements 5 and of the second series 4 of the guide elements 7.

The connecting rod elements 9 define an articulated parallelogram connection between the first series 2 of guide elements 5 and the second series 4 of guide elements 7. In order to create the articulated parallelogram connection, each of the second ends 12 of the guide elements 5 is connected by a respective connecting rod element 9 to the respective first end 13 of the guide elements 7 and each of the second ends 14 of the guide elements 7 is connected by a respective connecting rod element 9 to the respective first end 11 of the guide elements 5.

According to this arrangement, the guide elements 5 of the first series 2 and the guide elements 7 of the second series 4, starting from the rest position R, approach simultaneously the advancement zone 3, remaining in a position that is parallel to the axis X, until it adopts the engagement position L, coming into contact with the bar B.

The connecting rod elements 9 are pivoted on an oblong connecting plate 15, configured to be able to be mounted on support drum units 16 of a bar-feeding apparatus.

The oblong connecting plate 15 is fixed to the support drum unit 16 by screw members and/or by pin members provided at the pivots 10, so as to engage the screw members with corresponding holes made on the support drum unit 16. Other members of fixing the oblong connecting plate 15 to the support drum unit 16 can nevertheless be envisaged.

As mentioned above, the guide device 1 is configured to be mounted on apparatuses 18 for feeding bars B to a machine tool. The apparatus 18 includes the aforesaid drum unit 16 supporting a plurality of guide devices 1, as disclosed previously, for simultaneous loading of a plurality of bars B. The guide devices 1 are circumferentially distributed around the support drum units 16. The apparatus 18 further includes an advancement unit 20, 30, 40 for advancing the bars B to a machine tool.

Some embodiments of the advancement unit 20, 30, 40 are illustrated below.

In some first embodiments, with reference to FIGS. 8 to 10, the advancement unit includes a dragging chain or belt member 22 to which a dragging pusher 21 and/or bushing gripper is connected that is configured to come into contact with the bar B.

The chain member 22 is movable to translate the dragging pusher 21 and/or the bushing gripper, so as to advance a respective bar B along the advancement direction A. The chain member 22 is drivable by an electric motor of brushless type.

In particular, the pusher 21 comes into contact with the rear end of the bar B, exerting on the latter a thrust action that advances the bar B along the advancement direction A. In other words, the pusher 21 is configured to push from the rear the bar B, whilst the dragging bushing gripper, in which the bar B is inserted, is configured to move alternatingly, by a “pilgrim step”: during the retraction step, it slides without gripping the surface of the bar whilst advancing forwards it grips, with friction, the bar, causing the bar to move to the lathe. In another possible embodiment, combined or alternating with what has just been disclosed, with the chain member 22 a gripper can be coupled with grasping claw elements that are able to close or open to clamp and release the bar—alternatingly and synchronized with the pilgrim step movement thereof—so as to advance the bar by steps to the lathe.

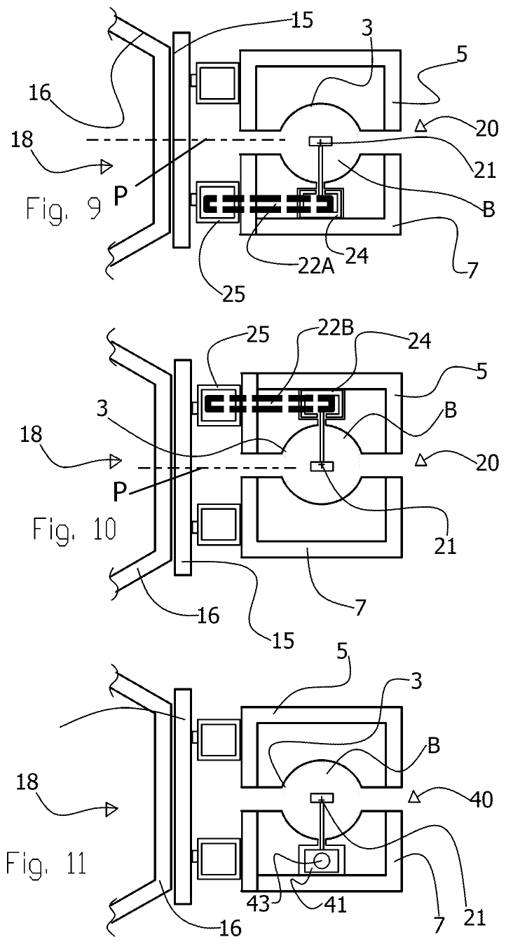

The chain or belt member 22 can alternatively include one, two or more chains, arranged according to different possible configurations. In the embodiment shown in FIG. 9, the chain 22A traverses the second 7 holding and guide arrangement. In the embodiment of FIG. 10, the chain 22B traverses the first 5 holding and guide arrangement. In another embodiment (that is not shown) it is possible to combine these two configurations that have just been shown.

The advancement unit 20 includes a containment and protection channel arrangement 24,25 inside which the dragging chain or belt member 22 is movable. The containment and protection channel arrangement 24,25 includes profile elements 24 that bound containing cavities and hollow profiled elements 25.

The profiled elements 24 with the containing cavities extend passing through inner zones of the first holding and guide arrangement 5 and/or second holding and guide arrangement 7. The profiled elements 24 have a section that is open—towards the advancement zone 3—such that from the respective open containing cavities connecting portions can protrude that connect the pusher 21 and/or the gripper to the respective branch of the chain, which is placed and movable inside the containing cavity.

The hollow profiled elements 25 are interposed between the first holding and guide arrangement 5 and/or second holding and guide arrangement 7 and the mechanical connecting elements 9. For example, the hollow profiled elements 25 can have a cross section (according to a plane that is transverse with respect to the axis X) with a closed polygonal profile, for example can be shaped according to the profile elements with a closed square or rectangular section. The cross sections of the channel elements 24,25 are sized so as to leave ample space to the respective chains 22 contained therein so as not to hinder the movement of the latter and not to hinder the movement of the first holding and guide arrangement 5 and/or second holding and guide arrangement 7.

The chain or belt member 22 moves along a closed circuit that extends inside the containing cavities of the channel arrangement 24 and 25 that has just been disclosed. Inside the aforesaid containing cavities, the chain member 22 moves so as to translate the dragging pusher 21 and/or the bushing gripper along the advancement direction A, so as to enable the dragging pusher 21 and/or the bushing gripper to perform the function of pushing and pulling and accompanying on the bar B. In this manner, the bar B is advanced to the machine tool. The movement of the chain or belt member 22, induced by the brushless electric motor, is reversed to enable the pusher 21 to be repositioned—once complete advancement of the bar B has terminated—upstream of the rear end of a new bar B to be fed, or to retract by an appropriate amount the dragging bushing gripper that must engage with the new bar B to be fed. During the advancement movement, the bar B is maintained in the correct position by the guide elements 5,7.

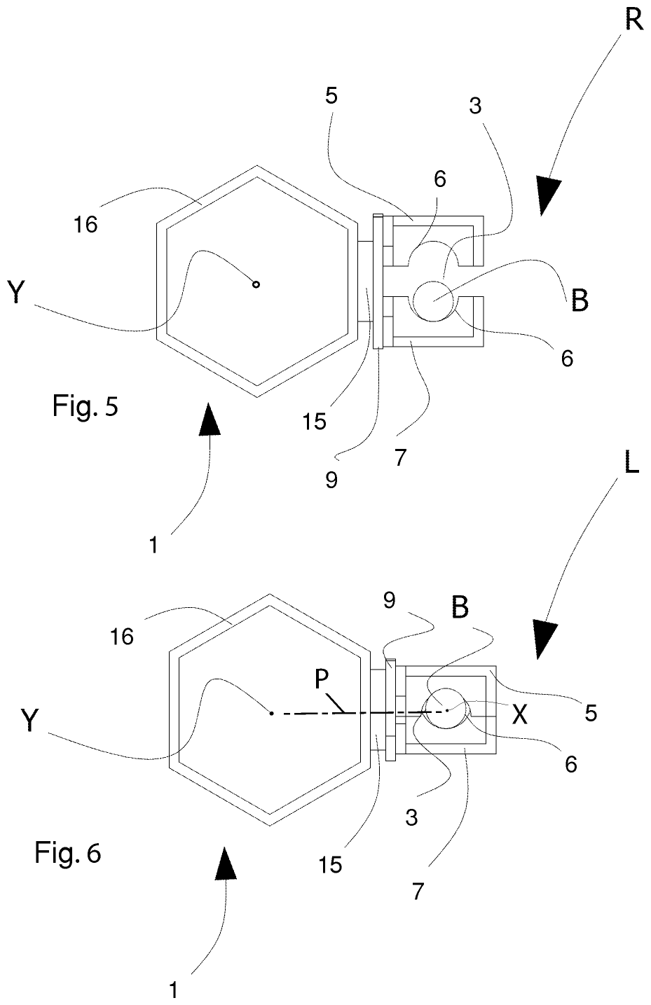

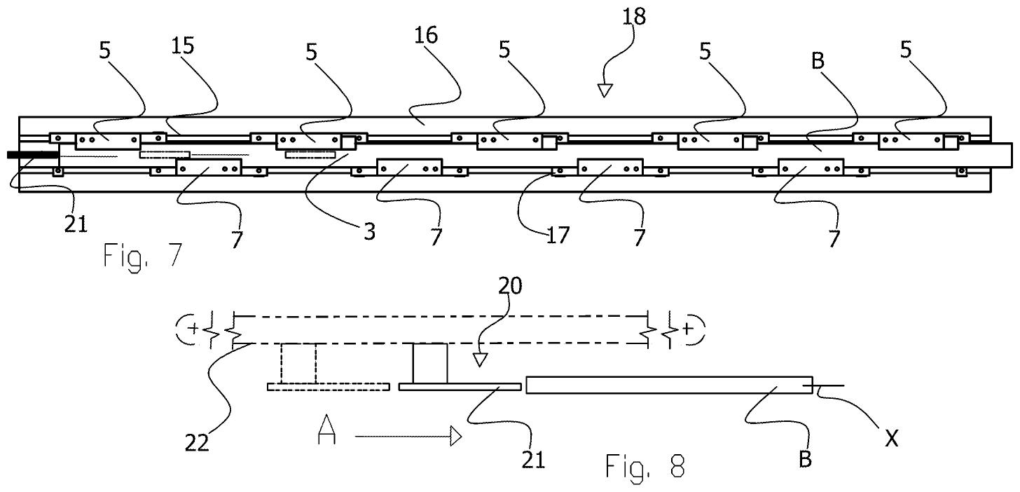

FIGS. 9-10 show schematically and by way of example the various possible configurations of the advancement unit provided with the belt or chain member 22. The radial plane P has been indicated (in FIG. 9), which is defined by the axis X and by an axis Y of the drum, visible for example in FIG. 5.

As visible in FIG. 9, in one embodiment, a chain element 22A is provided (to which a pusher or a bush gripper is connected) that extends on a plane parallel to the aforesaid radial plane P, traversing the first holding and guide arrangement 5. In another embodiment, visible in FIG. 10, a chain element 22B is provided (to which a pusher or a bush gripper is connected) that extends on a respective plane parallel to the aforesaid radial plane P, traversing the second holding and guide arrangement 7.

In another embodiment, it is possible to provide both the chain element 22A and the chain element 22B.

According to a still further embodiment, the advancement unit 40 includes a sliding rail track 43 mounted on the drum unit 16. On the rail track 43, a slide element 41 is movable, to which a pusher element 21 and/or a dragging bushing gripper is connected to advance a respective bar B along the advancement direction A. Similarly to what has been disclosed with reference to the system of advancement with belt member, also in the case of a rail track 43 and slide element 41 or cursor, it is possible to provide, mounted on the latter, one or more grippers with grasping claw elements that are able to close and open to grasp and release—in a manner alternating and synchronized with the pilgrim step movement—the bar that is thus advanced by steps.

In a first embodiment, the rail track 43 includes a magnetic or electromagnetic rail and the slide element 41 is an electromagnetic or magnetic unit. The magnetic or electromagnetic interaction with the rail 43 by the slide element 41 determines the sliding movement of the latter along the advancement direction A and in the opposite direction.

The slide element 41 advances along the magnetic rail 43, translating the dragging pusher 21 and/or bushing gripper and accompanying the bar B along the advancement zone 3. After guiding the bar B to the machine tool, the slide element 41 travels back in the opposite direction to the advancement path so as to permit advancement of a further bar B.

In a second embodiment, the rail track 43 and the slide element 41 are coupled with one another according to a screw-nut screw system. The slide element 41, coupled by a thread with a respective thread of the rail track 43, is moved, in the advancement direction A or in the opposite direction thereto, owing to the rotation of the rail track 43 induced by a motor, for example an electric motor of brushless type. The action of pushing and accompanying the bar B is identical to what was disclosed for the aforesaid case of the magnetic rail.

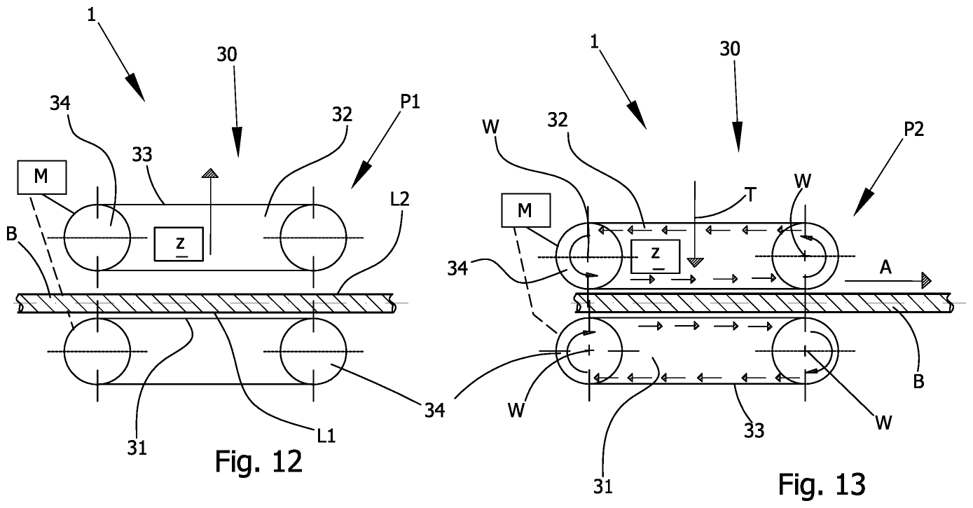

According to a further embodiment, shown in FIGS. 12 and 13, the advancement unit 30 includes a support and guide member 31 of the belt type or the conveyor type, configured to supportingly receive, on a first side L1, a bar B and to guide the bar B along the advancement direction A. The advancement unit 30 further includes a grasping member 32 of the belt type or the conveyor type along a direction T transversely to said advancement direction A from a disengagement position P1 to a locking position P1.

The support and guide member 31 and the grasping member 32 include a belt or a conveyor element 33 which is wound around a pair of wheel elements 34, that are spaced apart and rotatable around respective axes W, arranged transversely to the advancement direction A.

The belt or a conveyor element 33 is shaped to come into contact with the side surface of the bar B, to exert thereon the dragging action along to advancement direction A.

In the disengagement position P1, the grasping member 32 is furthest from the support and guide member 31, so as to result being separated from the bar B. In the locking position P2, the grasping member 32 is nearer to the support member 31 and presses longitudinally the bar B from a second side L2 opposite the first side L1 and against the support member 31.

An advancement motor-device M is provided that is configured to rotate the support and guide member 31 and/or the grasping member 32 in the locked P2 position and to drag and advance the bar B along the advancement direction A.

The motor device M includes an electric motor of brushless type.

A displacement member Z is further provided to translate the grasping member 32 from the disengagement position P1 to the locked position P2.

As is apparent from the above, the guide device 1 successfully achieves the set objects. The device 1 proves itself to be a simplified mechanism for guiding bars to be fed to a machine tool.

The device 1 is suitable for guiding bars with a wide range of diameters. In fact, the first holding and guide arrangement 2,5 and second holding and guide arrangement 4,7 are configured to adapt, during the operation of coupling and contact with the bar B to be guided, to the diameter of the bar B. The guide elements 5,7 approach and come into contact with the bar to be guided as far as possible, in function of the diameter of the latter, so as to ensure correct advancement of the bar to the machine tool.

The guide device 1 has a structural and functional configuration that is greatly simplified with respect to known apparatuses.

The simplicity with which the constructional elements of the guide device 1 are connected together implies a lower occurrence of faults or breakdowns and lower production and maintenance costs.

The operation of the guide device 1 is fast, efficient and reliable. Also owing to the structural simplicity of the machine, using the device 1 ensures high levels of productivity.

Any component that is part of the guide device 1 according to the invention can be replaced by other equivalents in structural and functional terms and the materials, inasmuch as they are compatible with the specific use for which they are intended, can be chosen appropriately in function of the requested requirements and in function of the available prior art.

Variations on and/or additions to what has been disclosed above and illustrated in the attached drawings are possible without thereby falling outside the claimed protective scope.

1. Guide device for bars to be fed to a machine tool, including a first holding and guide arrangement and a second holding and guide arrangement arranged to define an advancement zone for the bars, said advancement zone extending according to a longitudinal axis, said first holding and guide arrangement and said second holding and guide arrangement being configured to establish one or more contact zones with said bar so as to retain in position and guide said bar along said advancement zone, said first holding and guide arrangement and said second holding and guide arrangement extending parallel to said axis and being mutually positioned at opposite sides with respect to said longitudinal axis, said first holding and guide arrangement and said second holding and guide arrangement being relatively movable between a resting position, wherein said first holding and guide arrangement and said second holding and guide arrangement are at a greater mutual distance and at furthest positions from said advancement zone to allow the positioning of said bar to be guided along said advancement zone, and an engagement position, wherein said first holding and guide arrangement and said second holding and guide arrangement are at a smaller distance and closest to said advancement zone so as to come into contact with said bar adapting to different diameter values of said bar, said first holding and guide arrangement including a first series of distinct block-shaped guide-elements mutually spaced apart and distributed parallel to said axis and said second holding and guide arrangement including a second series of distinct block-shaped guide elements mutually spaced apart and distributed parallel to said axis, said guide elements of said first series of elements being arranged staggered with respect to said guide elements of said second series so as to entirely involve said advancement zone, said guide elements of said first series being mechanically connected to said guide elements of said second series by connecting members, so as to form an articulated guide structure, wherein said first series of guide elements and said second series of guide elements are movable in a simultaneous and synchronised manner between said resting position and said engagement position,
said guide device being WHEREIN said connecting members includes connecting rod elements the ends of which are connected respectively to a guide element of said first series and to a guide element of said second series, said connecting rod elements being configured to rotate around respective pivots.

2. Guide device according to claim 1, wherein on said first holding and guide arrangement and on said second holding and guide arrangement housing seats are obtained that are suitable for housing and guiding said bars.

3. Guide device according to claim 1, further including a driving member connected to an end of said first holding and guide arrangement and/or of said second holding and guide arrangement for moving said first and second holding and guide arrangement between said rest position and said engagement position.

4. Guide device according to claim 1, wherein said pivots are provided in an intermediate zone of the respective connecting rod elements and in a middle zone interposed between said first series of guide elements and said second series of said guide elements, so that a rotation of said connecting rod elements results in a displacement that is equal but in opposite directions of said first series of guide elements and of said second series of guide elements.

5. Guide device according to claim 1, wherein said connecting rod elements define an articulated parallelogram connection between said first series of said guide elements and said second series of said guide elements, so that said guide elements of said first series and said guide elements of said second series, starting from said rest position, approach simultaneously said advancement zone remaining in a parallel position with respect to said axis, until they adopt said engagement position, coming into contact with said bar.

6. Guide device according to claim 1, wherein each of said second ends of said guide elements is connected by a respective connecting rod element to a respective first end of said guide elements, and each of said second ends of guide elements is connected by a respective connecting rod element to a respective first end of said guide elements.

7. Guide device according to claim 1, wherein each of said housing seats has, according to a transverse plane, a curved concave profile.

8. Guide device according to claim 1, wherein each of said housing seats has, according to a transverse plane, a semicircular profile so as to define a cylinder-shaped advancement zone having a diameter with such dimensions as to house said bars with a diameter equal to or lower than said diameter.

9. Guide device according to claim 1, in which said housing seat is coated or integrally obtained in a single piece of material having anti-friction properties selected from a group including: polytetrafluoroethylene (PTFE), a polyamide containing graphite, a metal or metal alloy coated with graphite or a ceramic material.

10. Guide device according to claim 1, wherein said driving member includes a hydraulic or pneumatic actuator.

11. Guide device according to claim 1, wherein said connecting rod elements are pivoted on an oblong connection plate, said oblong connection plate being configured to be mounted on support drum units of a bar-feeding apparatus, and said oblong connection plate being fixable to said support drum units by screw members and/or by pin members provided at said pivots and engaging with corresponding holes made on said support drum units.

12. Apparatus for feeding bars to a machine tool, including a drum unit supporting a plurality of guide devices according to any one of the preceding claims, for simultaneous loading of a plurality of bars, wherein said guide devices are circumferentially distributed around said support drum units and including a unit for advancing said bars to a machine tool.

13. Apparatus according to claim 12, wherein said advancement unit includes:
a support and guide member of the belt type or the conveyor type configured to support, on a first side, a bar and configured to guide said bar along the advancement direction,
a grasping member of the belt type or the conveyor type, along a direction transversely to said advancement direction, from a disengagement position, in which said grasping member is furthest from said support and guide member so as to be separated from said bar, to a locking position, in which said grasping member is nearest to said support member for pushing longitudinally said bar from a second side opposite said first side and against said support member,
an advancement motor device configured to rotate said support and guide member and/or said grasping member in said locking position to drag and advance said bar along said advancement direction.

14. Apparatus according to claim 13, wherein said support and guide member and grasping member include a belt or a conveyor element which are wound around a pair of wheel elements that are spaced apart and rotatable around respective axes arranged transversely to said advancement direction, said belt or conveyor element being conformed to come into contact with the side surface of said bar to exert thereon the dragging action along said advancement direction.

15. Apparatus according to claim 13, wherein said motor device includes an electric motor of brushless type, and in which a displacement member is further provided to translate said grasping member from said disengagement position to said locking position.

16. Apparatus according to claim 12, wherein said advancement unit includes a dragging chain or belt member drivable by an electric motor of brushless type said chain or belt member being connected to a pusher and/or a dragging bushing gripper and/or a gripper with movable claw elements, configured to come into contact with said bar, said chain member being movable to translate said pusher and/or said dragging bushing gripper so as to advance a respective bar along said advancement direction.

17. Apparatus according to claim 16, wherein containment and protection channel arrangement is provided inside which said dragging chain or belt member is movable, wherein said containment and protection channel elements include profile elements with containment cavities obtained inside said first and/or second holding and guide arrangement, and hollow profiled elements interposed between said first and/or second holding arrangement and said mechanical connecting elements.

18. Apparatus according to claim 12, wherein said advancement unit includes a sliding rail track mounted on said drum unit and on which a slide element is movable, which is connected to a pusher element and/or a dragging bushing gripper and/or a gripper with movable claw elements, to advance a respective bar along said advancement direction.
